(19) United States
(12) Patent Application Publication
(10) Pub. No.: US 2019/0287044 A1
(43) Pub. Date: Sep. 19, 2019

(54) EXTENSIBLE, ADAPTIVE, INTELLIGENT DATA COLLABORATION PLATFORM

(71) Applicant: Adorant Group LLC, Chicago, IL (US)

(72) Inventors: Brian Mantel, Naperville, IL (US); Buddika Gajapala, Naperville, IL (US)

(21) Appl. No.: 16/356,930

(22) Filed: Mar. 18, 2019

Related U.S. Application Data
(60) Provisional application No. 62/644,965, filed on Mar. 19, 2018.

(51) Int. Cl. G06Q 10/06; G06Q 40/02; G06N 7/02; G06N 5/02

(52) U.S. Cl. CPC G06Q 10/063112; G06N 5/02; G06N 7/023; G06Q 40/02

(57) ABSTRACT

Systems and methods are disclosed for client-advisor collaboration. An example system includes a server in communication with a client device, configured to receive one or more client metrics input via the client device. The system also includes a profiling engine in communication with the server and configured to: receive the client metrics and the advisor metrics, determine one or more implied client metrics based on the received client metrics, and generate a plurality of client tags corresponding to a client based on (i) the one or more client metrics, (ii) the one or more implied client metrics, and (iii) one or more profiling rules. The system also includes an education engine configured to: determine one or more knowledge entities based on the generated plurality of client tags, and transmit the one or more knowledge entities to the client device.

### RELATED APPLICATIONS

This application claims the benefit of U.S. Provisional Patent Application No. 62/644,965, filed on Mar. 19, 2018, the contents of which are herein incorporated by reference.

### TECHNICAL FIELD

The invention relates to systems, methods, devices, and other approaches to providing bionic discovery, learning and strategy formulation in a multi-actor, dynamic, state-dependent technology platform with multiple simultaneous variable endogenous and exogenous factors enabled with an extensible, adaptive and intelligent data model and architecture. In particular, embodiments disclosed herein may relate to advice, and various approaches to establishing client-advisor relationships, information gathering and dissemination, forecasting, and various other concepts related to advising.

### BACKGROUND

As noted above, embodiments disclosed herein may relate to advising. In particular, these embodiments may related to providing a mechanism for clients and advisors to meet, develop a relationship through communication of relevant information, and share information with each other in order to more seamlessly and intuitively develop plans and strategies, solve problems, and collaborate.

As such, embodiments may make use of particular computing systems and/or devices, architectures, data storage, data analysis, communication methods, and other specific technologies in order to carry out the functions described herein.

### SUMMARY OF THE INVENTION

Embodiments disclosed herein may include an expert system that allows diverse actors and expert partners to reveal and share information that they have unique, individual knowledge where the other party does not have the same knowledge. These diverse actors share their knowledge and expertise through an intelligent information discovery, education, learning and collaboration data processing system that leverages insights from algorithms, technology and experts, and end users expert in their own goals and assessments of trade-offs, to collaborate efficiently in ways that foster creativity and learning while tracking accountability for inputs, assumptions and changes by actor. Embodiments may also include built in fault tolerances to minimize lapses in data collection, data contributions, information analysis, and advanced analysis of over forty potential data inputs to a series of models.

This intelligent collaboration platform builds and fosters two-way trust and increases engagement and buy-in from multiple diverse system actors, including information discovery, learning and collaboration occurring outside of formal, prescribed windows which increases the likelihood of fuller learning. Embodiments may also include an adaptive technology architecture, database design and data model that allows new data elements to be added in iterations while maintaining the integrity of the expert data gathering, intelligent analysis, and advanced scenario modeling tools. This allows rapid evolution of the smart system to increasingly evolve with the industry's growing knowledge of complex and multi-faceted decision-making and complex and multi-faceted data modeling and analysis.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings.

FIG. 1 illustrates a simplified block diagram illustrating aspects of various embodiments of this disclosure.

FIG. 2 illustrates an example data architecture of embodiments of the present disclosure.

FIG. 3 is another illustration of example data architecture of embodiments of the present disclosure.

FIGS. 4A-4C illustrate simplified network architecture diagrams according to embodiments of the present disclosure.

FIG. 5 illustrates an example learning system according to embodiments of the present disclosure.

FIG. 6 illustrates an example simplified diagram of advisor-client matching according to embodiments of the present disclosure.

FIG. 7 illustrates an example simplified block diagram of a machine learning process that may be used to determine the best client/advisor match.

FIG. 8 illustrates an example simplified block diagram of a system for determining and storing changes to various records used in embodiments of the present disclosure.

### DETAILED DESCRIPTION

While this invention may take various forms, there is shown in the drawings and will herein be described in detail various embodiments of the invention with the understanding that the present disclosure is to be considered as an exemplification of the principles of the invention and is not intended to limit the broad aspect of the invention to the embodiments illustrated.

In general, advice today may be formulated in two different domains. The first traditional path occurs in a primarily physical domain where clients and advisors conduct significant paper-based, email-based and telephone based information discovery, supplemented with physical use of financial planning and forecasting systems heavily reliant on a few knowledge experts. On the one hand, there is a level of quality control this path allows, while on the other hand this is a very slow, linear process which can take months from beginning to completion. A further more significant and under-appreciated challenge is that there is limited learning and engagement by the client and the primary advisor is often divorced from the advice creation process, and may be subordinated to primarily information delivery rather than strategy formulation and optimization. The net effect is a process that can take months, can feel dated and that disengages rather than engaging and empowering the most important person: the end client, leading to less buy-in to the recommendation, less belief and comfort in the relationship with the advisor, and lower likelihood of recommending an advisor to friends and family.

The second path, emerging recently, may be referred to as the “robo-advisor” path in which computer systems perform data gathering, information analysis and provide the ultimate recommendation (within tolerances established by the robo-advisor firm, where clients meeting certain net worth or other triggers are off ramped to the traditional in-person, physical advisor team. This path, while much quicker and requiring less human capital, is fraught with difficulties including client data gathering errors because the client misunderstands the question, not understanding the terminology used, having imperfect recollection or imperfect access to data, data entry errors, or lack of interest and attention by the client. A follow-on family of problems may occur where imperfect robo-advisor algorithms don't adequately capture the necessary data; where they fail to account for multiple factors, or where they fail to allow for critical learning to occur with the client through joint client-advisor discovery and learning as data is reviewed, inquired on and put into context based on a relationship.

Compounding these information discovery, information analysis, and system learning challenges are the technology limitations of current data processing systems which limit the ability of multiple parties to jointly contribute data, contribute algorithms, conduct analysis, and advance not only information discovery and analysis, but complex learning and definition of multiple complex, inter-dependent financial scenarios among parties with limited understanding, limited ability to process multiple uncertain variables and with data that often changes in multiple exponential paths (rather than more easily understood linear paths).

The example systems and methods disclosed herein enable a client to be matched with an advisor in a more useful and timely manner. The systems and methods also enable a more accurate and/or appropriate match to be made, providing each client with an advisor he or she is more likely to connect with, trust, and develop a beneficial relationship. The examples disclosed herein include a specific set of system features and rules that provide an improved technological result in automatically matching a client to one of a plurality of potential advisors. Through the use of machine learning and fuzzy logic, the disclosed systems and methods attempt to solve longstanding problems such as those noted above. Particular examples include an ordered combination of non-conventional pieces that form particular, practical applications for matching clients to advisors.

Further, examples disclosed herein include improved user interfaces for computing devices that are particularly structured to present applicable information to clients and advisors in an easy to follow, time-efficient manner. For example, A client may enter a set of information including various financial, behavioral and demographic information. The example systems and methods may extrapolate from this input information to determine “implied” client metrics that can be used in the various steps and elements of the disclosed examples. Thus, the examples disclosed herein provide improved usability of a computing device, by including interfaces that are specifically configured to gather relevant information from clients and advisors, and to provide appropriate educational content to the client.

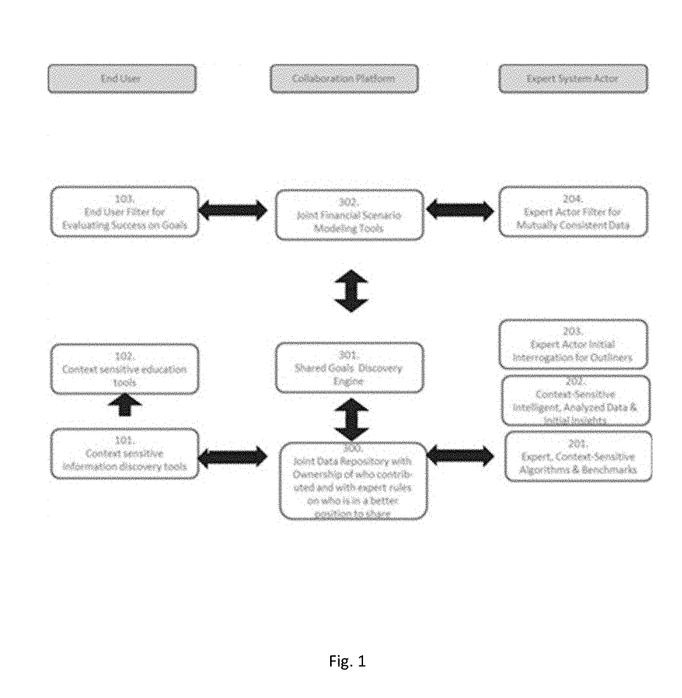

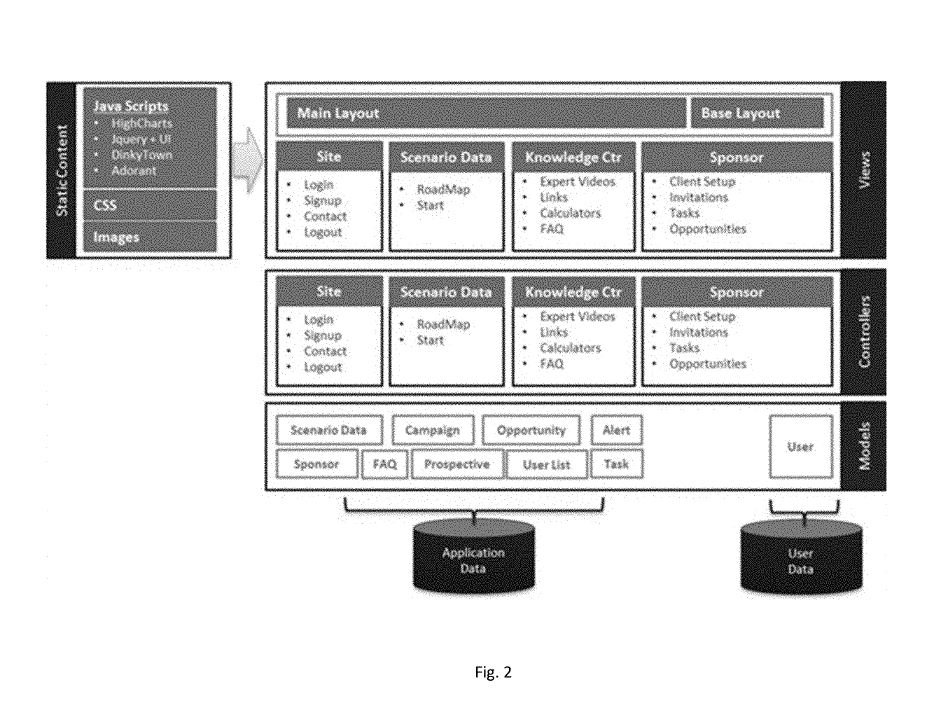

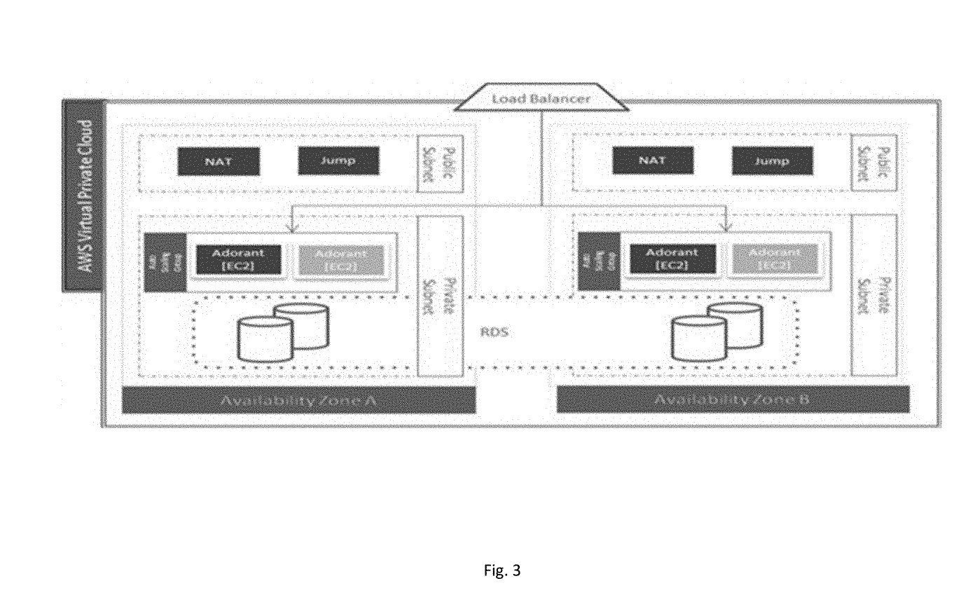

FIG. 1 illustrates a simplified block diagram illustrating aspects of various embodiments of this disclosure. FIG. 2 illustrates an example data architecture of embodiments of the present disclosure. And FIG. 3 is another illustration of example data architecture of embodiments of the present disclosure.

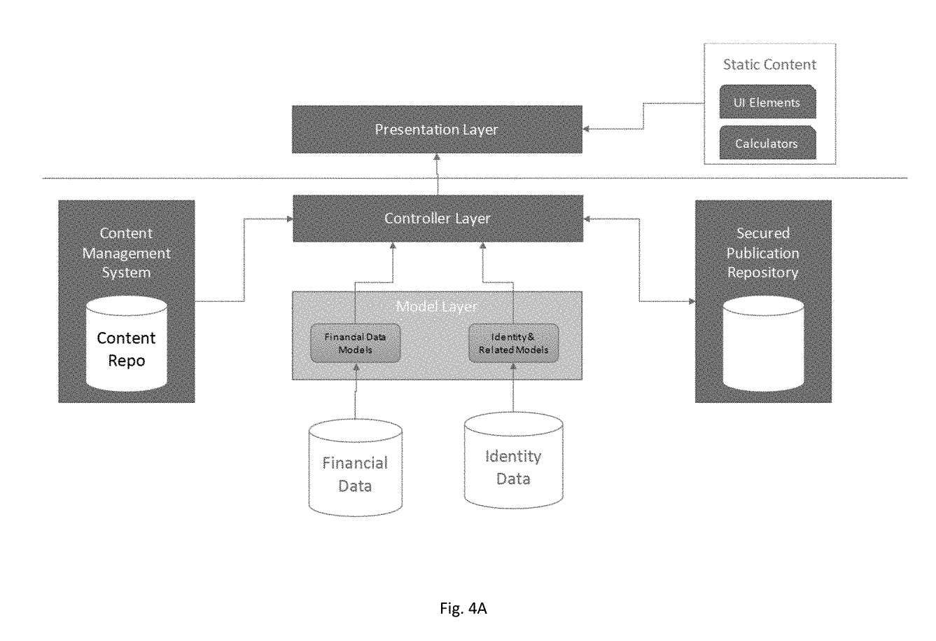

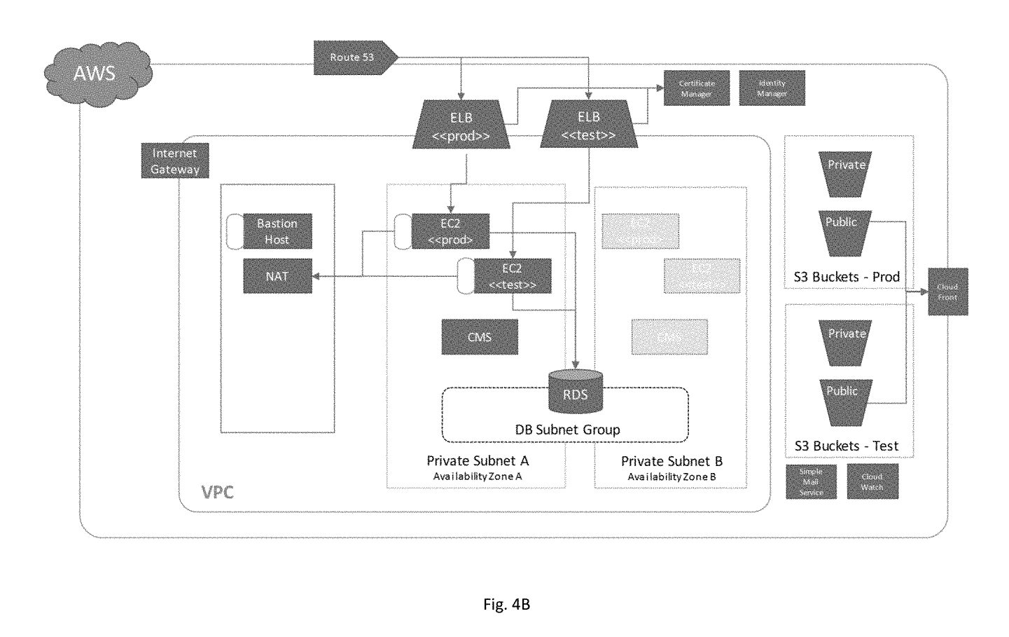

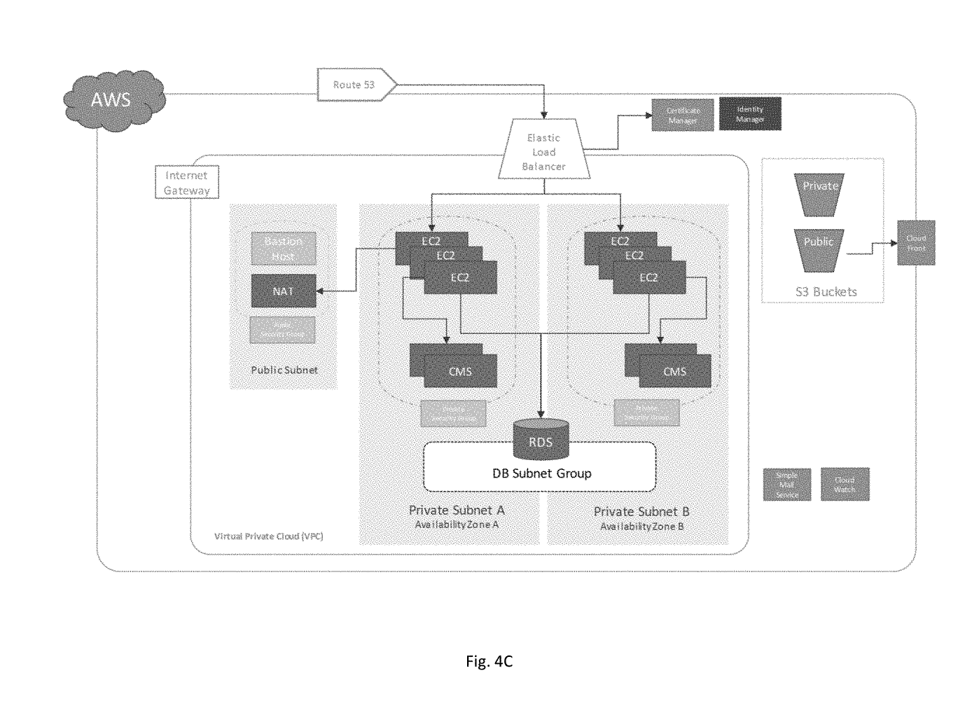

FIGS. 4A-C illustrate example simplified network architecture diagrams.

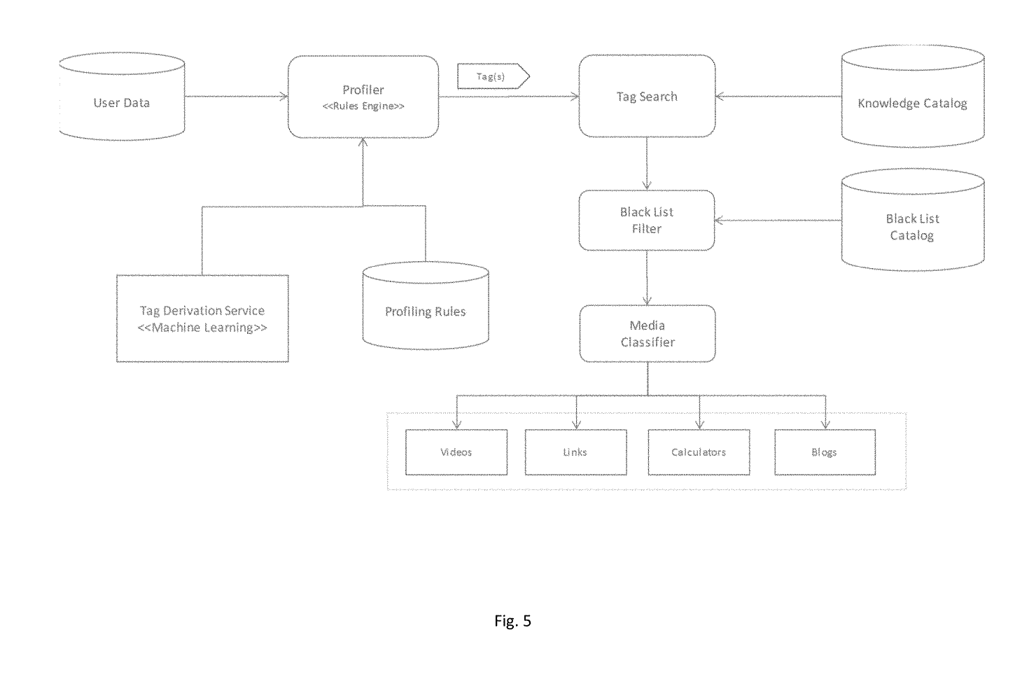

FIG. 5 illustrates an example simplified block diagram of a learning system by which one or more systems or devices of the present disclosure may curate learning content for various audiences. Material may be presented to clients in the most applicable fashion, in order to avoid information overload. Further, clients may not be able to explicitly express what kind of content is most useful for them.

With these issues in mind, the learning system may be configured to obtain “implied” knowledge from the client based on their data, goals and demographics, and other factors, to present the client with only the most relevant content.

FIG. 5 may include profiling of the user data. This profiling may be done using various rules. The profiling of the user data may be data driven, and implemented as one or more functions. Each rule may accept User Data as a Java script object and return an array of Tags. Each rule may also have a default weight and status (indicating whether it is active or not). In some examples, rules may be hierarchical (i.e., Global, Sponsor, Advisor, Client Organization). Each Tag may have a Qualifier, a Value, and a Weight. Example tags may include (1) gender:M:0.2, (2) generation:X:0.5, and (3) wealth_tier:5:0.8. It should be appreciated that these tags are for example only, and that there may be many other tags to be used for behavioral and wealth segmentation, among other purposes. Note that tag derivation logic may be implemented in each rule and may use one or more attributes from the incoming user data object. A weight for each tag can be common for entire rule or specific to each tag.

In FIG. 5, the profiler loads the rules and uses them to profile the user by generating tags. A super set of all the tags generated by all the active rules may be used to compile a “Fuzzy” search by Tag Search module on the Knowledge Catalog for best matching knowledge entities.

The Knowledge Catalog of FIG. 5 may be data driven, and may store data as documents on a Text Search engine (e.g Lucene) based NoSQL database (e.g. Solr, Elastic Search). Each entity may have (1) a Unique Id, (2) Title, (3) Description (Optional), (4) Map of Info References (e.g. link, image url, etc), (5) Set of Tags (Suggesting which tags this knowledge entity is applicable to), (6) Entity Class—what kind of information this is (e.g. Video, Blog, Calculator), (7) Owner (Global, Sponsor, Advisor, Client Organization)—This will help Sponsors, Advisors, Client Organizations to bring their own data thru exposed API, (8) Status (Active, Inactive), and/or (9) Social Metrics (Ratings, Views etc).

The Black List Catalog of FIG. 5 may include a list of Knowledge Entities (IDs) that are black listed. Each black list entity may have (1) a Unique Id, (2) Knowledge Entity ID, (3) Description (Optional), (4) Owner (Global, Sponsor, Advisor, Client Organization)—This will help Sponsors, Advisors, Client Organizations to manage their own blacklist, and/or (5) Status (Active, Inactive).

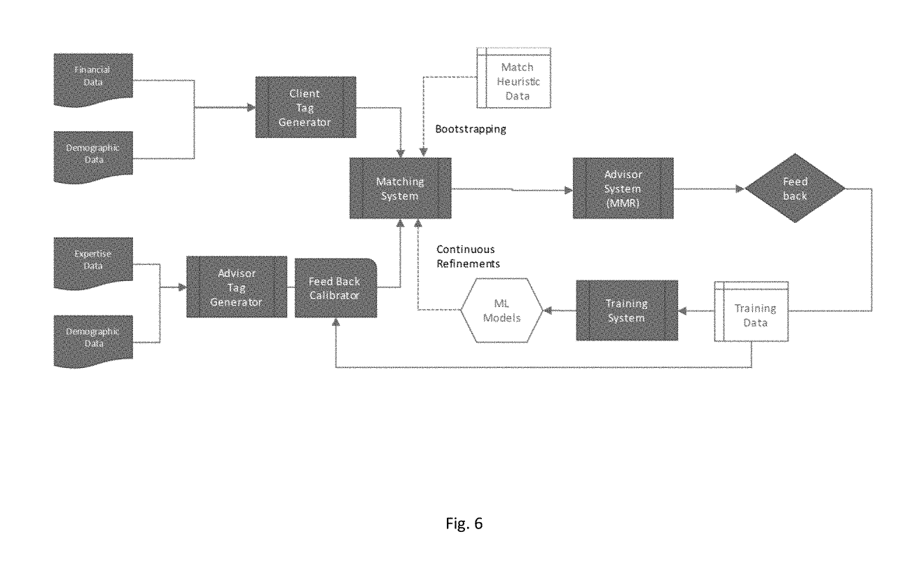

FIG. 6 illustrates an example simplified diagram of advisor-client matching according to embodiments of the present disclosure. The present disclosure may describe embodiments that make up a collaboration platform for a large eco-system of advisors and coordinators to better service clients in a cost effective manner. In this process it is imperative to match clients and advisors based on client needs and advisor capabilities. Similar to the learning system described with respect to FIG. 5, clients may not explicitly identify their needs, where they need help etc. As such, the purpose of the advisor-client matching system is to provide a mechanism to match clients and advisors to best address their goals and future.

With respect to FIG. 6, clients' data and demographic data may be sent to the Client Tag Generator to generate tags based on the information. Similarly, advisors' expertise data and demographic data may be used to generate Advisor tags. In both cases, tag generation can be done through heuristic categorization.

Advisor Expertise tags may be calibrated (up or down) based on client feedback. For a given client, the matching system may iterate through some or all of the Advisors (using advisor tags for each advisor) to score each advisor's suitability for assisting that client's needs. This scoring is done by cross referencing the Match Heuristic Data table initially.

After the Advisor/Client sessions are conducted, the client may be presented with a feedback survey, on which questions are asked and answered to determine the satisfactory levels for each expert area of the advisor. This information may be used to build a training data set to build a machine learning model. When the machine learning model reaches a satisfactory level on its predictions, the heuristic model may be disengaged and the machine learning model may be used instead. Further, the machine learning model may be continuously tuned or trained based on feedback data and other information gathered from clients, advisors, and other systems.

Client Tags—Client Tags may be derived based on the financial and demographic data for one or more clients. Each tag has a qualifier and a categorical (discrete) value. For example:
Demographic Tags
   gender: M
   gen: X:
   edu: 5
   Behavioral preferences: J
Wealth Level and sophistication
   wealth_tier: 5
   inv_mut_ funds: 5
   inv_eqt: 8
   inv_other: 2
Goal Tags representing significance of each goal (retirement planning, college planning, mortgage, etc.)
   goal_rp: 8
   goal_cp: 3
   goal_mort: 5

Advisor Tags—Advisor Tags may be derived based on the expertise and demographic data of one or more advisors. Each tag has a qualifier and a categorical (discrete) value. For example:
Demographic Tags
   gender: M
   gen: X:
   Behavioral preference: P
Portfolio Tags
   portfolio_scale: 5 (Combined wealth of clients)
   portfolio_scale_90:5 (Combined wealth of 90% of clients)
   portfolio_size: 8 (How many clients)
Expertise Tags
   exp_rp: 8 (Expert level for retirement planning)
   exp_cp: 5 (Expert level for college planning)
   exp_mort: 2 (Expert level for mortgages)

Example pseudo code for generating a match score between an advisor and a client may include:

clientTags =
generateClientTags(clientFinancialData,clientGoals,clientDemo)
maxScore=0
advisor=null
For each Advisor (as currentAdvisor){

advisorTags=
generateAdvisorTags(advisorPortfolioData,advisorQuali

fications,advisorDemo)

caliberatedAdvisorTags =
caliberateAdvisroTags(advisroTags,clientFe

edBackData)

matchScore = SQL−> Select sum(cross_weight) where advisor_tag

in advisorTags and client_tag in clientTags

if (matchScore>maxScore){

maxScore=matchScore
advisro= currentAdvisor

}

}
return advisor,maxScore

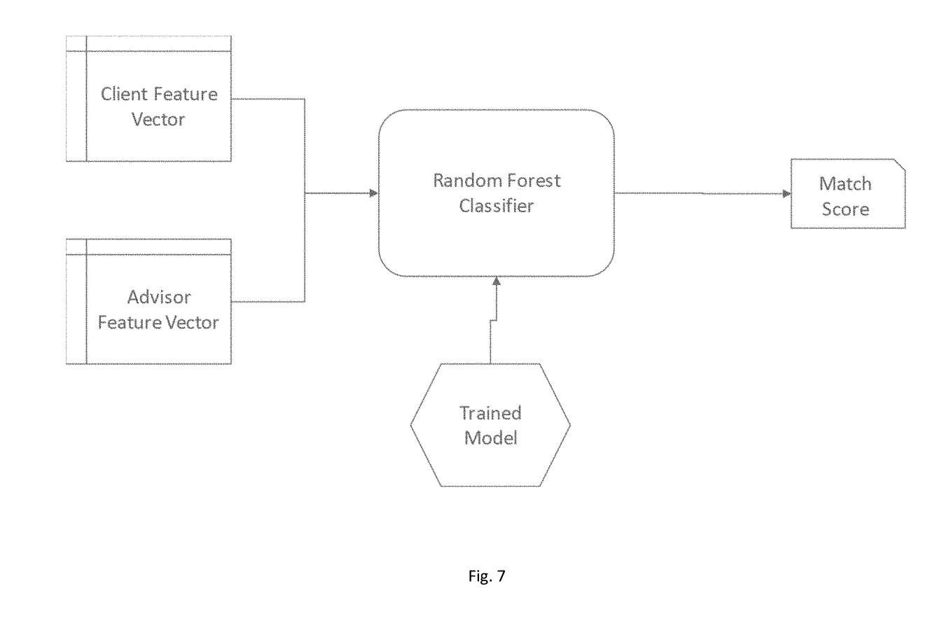

FIG. 7 illustrates an example simplified block diagram of a machine learning process that may be used to determine the best client/advisor match.

Feedback based advisor ratings may be calculated using a “time-decayed” weighted average of the feedback rating (1-10) for each FeedBack class (FB_EXP_CLASS). FeedBack Metric (FB_METRIC) may be a fine grained feedback element that can be grouped in to a FB_EXP_CLASS. As an example, an Advisor may provide several types of advice related to buying a house, such as (1) Mortgage amount/percentage etc., (2) Down payment options, (3) Rate/points etc. Any such atomic level advice can be rated by Client, based on how well the advisor helped her, understood her needs etc. These advice ratings can be grouped in to general classes of advice (e.g. mortgage) which is directly mapped to the advisor's experience for later use. In some examples, feedback from a client may include a client ID, an advisor ID, a feedback advice ID, a feedback rating, and a time stamp.

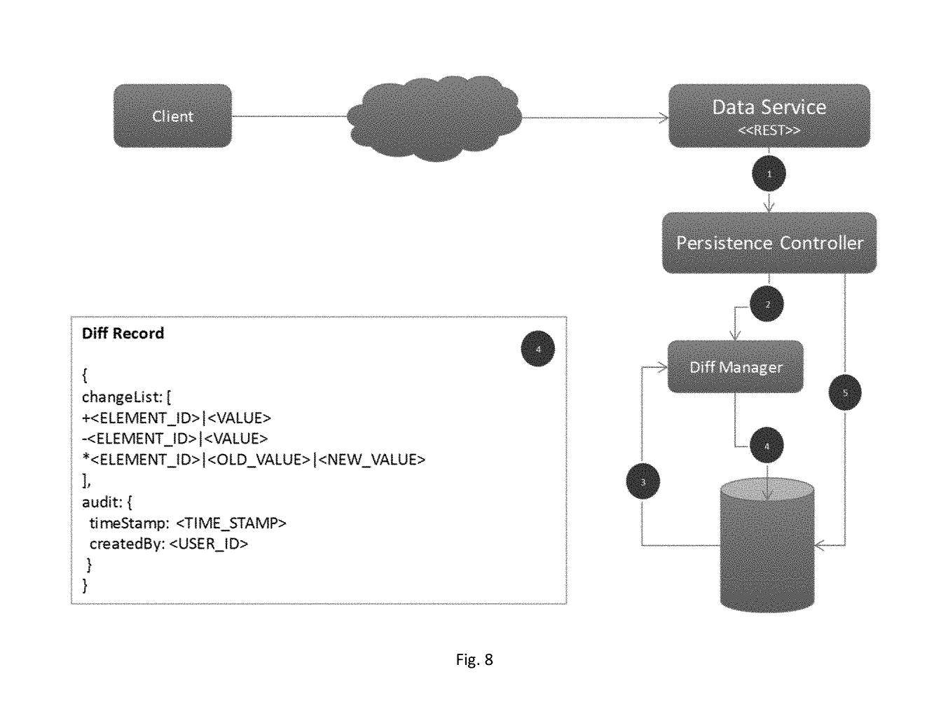

FIG. 8 illustrates an example simplified block diagram of a system for determining and storing changes to various records used in embodiments of the present disclosure. FIG. 8 may provide an easy way for both Client and Advisor to manipulate data corresponding to the client. The system maintains a journal of modifications to this data for regulatory, troubleshooting and future enhancement purposes. The design of FIG. 8 may provide a solution configured to capture, research and reproduce changes to clients data records.

Methodology

In some examples, the systems described herein may make up a platform referred to as the “Collaboration Platform” (CP) that helps provide clients expert-informed, multi-actor, multi-year action plans. Throughout the platform, we gather general information about priorities, current state data, along with several hypothetical scenarios and illustrate how those scenarios may perform over time.

The Collaboration Platform (CP) may be driven by the inputs and assumptions outlined by the client and advisor. Using these inputs and assumptions, embodiments described herein may first estimate a consumer's future state requirements using current data, future state assumptions, future choices and other environmental assumptions. Second, CP estimates requirements for alternative plans, which leverages a client's assumptions and assumptions provided by experts. Third, CP provides the consumer and advisor with forecasts of total outcomes driven by system choices, assumptions and scenarios. The client and advisor are able to run multiple simulations to best optimize paths to accomplishing client goals. Fourth, CP enables the client and advisor to stress test multiple critical assumptions and choices, the net effect of which is to highlight to make explicit natural uncertainties in the environment.

To allow for apples-to-apples comparisons to various tools, CP may allow the user to configure various methodology assumptions (e.g., the timing of certain choices, detailed modeling protocols). To test the reliability of these results, the platform also periodically tests its modeling relative to other commonly used modeling packages.

A combination of the inputs and assumptions are the basis of the modeling. The tool analyzes inputs that are easy for a client to provide. The tool may grow most dollar amounts with inflation each year, adjusting for the cost of living.

| Input | How the input is used in the tool |
|---|---|
| Month/Year | Provides your current age, number of years until retire- |
| of birth | ment, and number of years within retirement. |
| Planned | Determines the time horizons used in the assessment. |
| Retirement | This includes both the number of years from today until |
| Age | retirement and the number of years expected from the |
| | start of retirement to the end of your life expectancy. |
| Approximate | Used to estimate your future retirement income from |
| annual | Social Security, which is automatically included in the |
| household | analysis. As well, savings contributions are based on |
| income | current income and grow as your income grows. |
| Life Horizon | Combined with Retirement Age provides number of |
| | years retirement income is required. |
| Planned | Income during retirement needs is based on a percentage |
| income | that you choose. To maintain your current lifestyle |
| replacement | select 80%. Adjust as appropriate to meet your needs |
| | (such as reduced debt - especially mortgage, or increased |
| | medical expenses). This is also used to compare to your |
| | “sustainable annual spending” to determine whether you |
| | are on track to achieve a successful retirement. |
| Household | Liquid savings will be added into your net worth and also |
| rainy day | support your financial health status. |
| funds | |
| Savings and | Along with assumed savings rates and market expecta- |
| Investments | tions, is used to calculate your Estimated Portfolio |
| | Balance at Retirement, which in turn determines whether |
| | you are on track to meet your retirement spending goal. |
| | Assets, along with annual increases, are also illustrated |
| | on the annual income statements and balance sheets. |
| Employer | Is included in retirement income where applicable. |
| Pension Plan | |
| Insurance | Status will be included in your documents list. |
| and Estate | |
| Spending and | Your mortgage and household debt contribute towards |
| Debt | your financial health calculations. |
| Risk Appetite | These responses will help your advisor get to know you |
| | and your investment style, and what resources you may |
| | find beneficial. |
| Goals | Funding for your goals will be automatically built into |
| | your retirement plans. |
| Retirement | Select your ideal retirement age to forecast your retire- |
| Age | ment lifestyle. |
| Current | Saving contributions, as a percentage of income, will |
| Savings | grow as your income is forecasted to increase. Helps |
| Percentage | determine whether you are currently saving enough for |
| | your future retirement. Also supports determining your |
| | alternative retirement solutions: reduce retirement |
| | spending or delay retirement. |
| Social | Select an age between 62 and 72 to start receiving |
| Security start | benefits. It is not necessary to match your benefits start |
| age | year with your actual retirement start year. |

The tool may also incorporate one or more assumptions by default.

### EXAMPLE PLATFORM USE

The CP can be used by both clients and advisors, and each may have a different experience when using the platform. From the Advisor's perspective, CP builds on the disciplined five step financial planning process: (1) gather data, (2) analyze, (3) review, (4) implement, and (5) monitor.

From the client perspective, CP was built to cultivate quick, easy and seamless data gathering; to provide tips along the way; to give you a chance to review and confirm information before proceeding to a new section, leveraging best practices in user experience. CP also provides you valuable information and insights along the way, helping you see how you're doing and where you might want to spend additional effort. You'll get these insights as you proceed in the tool and then cover them in more depth when you and your Advisor meet. CP also recognizes that you may not have all the exact numbers at your fingertips and that's okay. You'll have the chance to update and validate numbers when you meet with your Advisor and to update it throughout the relationship as you get new and better information. What's important is that you start and are updating as you go.

Step 1 may include gathering basic information from the client, including biographical information, priorities, savings, spending and much more in order to gain a clear picture on you, your current situation and where you want to go.

Step 2 may include collaboration between the client and advisor to quantify their goals, assess retirement scenarios, and discuss financial plans. Scroll to view their profile summary, personality type and roles. Note the User Management, Review Client Info, Review Action Items and Approve Roadmap tabs. The User Management indicates basic information about your client and the roles you've assigned to them. As your relationship with the client progresses, you'll want to begin with “Start”, and then build onto “Plan” and eventually “Manage”. In rare circumstances would you wish to give a client an Advisor or Administrator role. The Review Client Info features Start, Plan and Manage tabs and are a direct reflection of the client's view and specific inputs. Make adjustments to their inputs to formalize their financial plan. The Review Action Items has two tabs—the first, Advisor View, is topics suggested by the CP based on the client's inputs. The second tab, Other, allows you to create custom recommended implementation steps. Advisor Blogs feature leading financial and advisor information to keep current on. The Approve Road Map tab enables you to release one of multiple levels of reports to your client.

Step 3 may include developing a long-term relationship between the client and advisor. The advisor will now formalize your financial plan and implementation steps with target dates and invite you into the Manage portion of the CP portal. You'll have access to very advanced tools to see your precise current situation; specific next steps that you should take; easy “what if” scenarios; suggested articles and videos; and a place to store all your financial information and contacts in one convenient area. At this time, you'll also gain access to the Learn tab which features a comprehensive knowledge center of articles, videos, online calculators, books and over one hundred common consumer FAQs. Your advisor will send regular emails and automatic reminders to help keep you on your path, and you'll be able to conveniently book annual checkpoint meetings with access to your advisor's calendar.

Additional Details

In some embodiments, Application data and User Information (PII) may be stored in separate databases. Further, limited data may be requested from the user in order to preserve privacy. Data may be partitioned in separate databases in order to maintain privacy of sensitive information. Partitioning data processing may be done both server side and browser side. Further, the particular data structures used may allow for flexible and adaptive change of the data structure.

Embodiments of the present disclosure may factor in various regulations and laws pertaining to advisor client relationships. In order to meet this requirement, CP may collect data on client risk preferences, client risk capacity/readiness, time horizon and through collaboration documents the results of very technical analysis in a way that a non-financial expert can understand. The system will allow the client to acknowledge that the advisor has completed the analysis; presented and discussed, and the client understands and acknowledges the client acknowledges and allows for record keeping in one click fashion.

In some embodiments, the platform may use a document style CLOB for all the user financial data for easier expandability and speed, allowing advisors to customize and configure data and methodologies. The platform may also allow the client, advisor, and advisor's firm to each contribute to key inputs, assumptions and methodologies to allow the entity with the best knowledge to inform the plan and to allow the plan assumptions to change over time based on the input of different parties.

The platform may allow clients and advisors to collaborate jointly on a financial plan providing data entry, financial analysis, financial scenario analysis and creation of go forward choices and allow the client and advisor to track versions and who last contributed to the assumptions/choices.

The platform may use document style CLOB for all the user financial data for easier expandability and speed, allowing advisors to customize and configure data and methodologies. The platform may also enable bionic flexible financial analysis that allows the best person (or person having the most relevant information) among various trusted parties to provide data, defaults or assumptions. The platform may also allow tracking of learning over time and documenting the plan creation, delivery and acceptance. The platform may also provide automated financial coaching developing pre-configured financial advice, allowing the advisor to review, update and approve it.

The platform may allow client specific real time and asynchronous communication, client-advisor collaboration communication and advisor specific communication. The platform may also allow the tracking of inputs, goals, financial analysis, financial scenarios and providing version control in a multi-party environment with complete flexibility over the review of the information. In particular, the platform may allow multi-path communication with immediate communication when both parties are online, asynchronous communication when they are offline and tracking action items from initiation, to review to closure in a way that ties these multi-mode communications back to an integrated financial roadmap. Integration of calendaring, action items, and financial education in a way that makes follow-up communication more seamless and impactful, and allowing for the delivery of educational content automatically based on similar individuals accounting for financial, demographic, behavioral and other preferences.

In some cases, the platform provides a customized financial health check-up, versioned to your age and income and providing a 0-100 scale and red, yellow green output format that provides immediate real time feedback to a client which has both informational and educational benefit. The platform may provide a comprehensive overview of retirement readiness and ability to meet various goals, allowing the user to piecewise select which goals to include and which assets to include or not include in a calculation. This supports broader industry goals of allowing consumers and advisors more control over how consumers choose to bucket cost and assets for financial planning purposes.

In some cases, the platform allows for automated re-review of all data in real time to regularly check for changes in your financial health, financial goals and opportunities and aggregating those opportunities for both advisor and client and delivering them at the right time and with other relevant information that improves value to the client and the advisor.

In some cases, particularly for scenarios involving large advisor firms, the platform may optimize recommendations for a client/advisor match, as well as specific client financial recommendations, based on 1) client needs, 2) firm capabilities, 3) firm's key employees matched to the client based on psycho-financial behavioral traits. The platform may also automate delivery of select information that the client and advisor control—permission—and allow to be shared with the referral party. So an advisor does not need to ask the client all the obvious questions like age, income, occupation, etc. The platform will come delivered along with your status of advancing into a financial roadmap to increase relationship and trust among the two parties to increase the likelihood of a match.

Some examples may also include algorithms that note cautions or red flags to both parties to be looking for early in the relationship that might suggest this match is not ideal or well suited. This may help refine matches and build trust when a client's information is shared. The platform may also allow for controlled and secure delivery of only certain approved information elements in the viral relationship and that allows for tracking of who has seen the information, adding additional compliance tracking.

It should be appreciated that the concepts described herein may also apply to one or more systems, devices, and/or methods for developing, generating, or otherwise determining financial models and financial planning scenarios. This may include a system having a modeling engine, wherein the modeling engine comprises one or more processors and/or memory having instructions stored thereon for carrying out the various functions or actions described in this disclosure and in the claims. In particular, examples may include receiving inputs from one or more clients, one or more advisors, and one or more advisor firms. The systems, devices, and methods may enable specialization and customization, particularly with respect to tracking of the source of the input (e.g., client, advisor, or firm). This can be particularly useful due to regulatory and compliance pressures that require transparency in the source and rationale for various calculations in the client-advisor relationship. Previous systems are opaque, and do not allow as much transparency in the decision making that occurs with respect to building models.

Examples may include tracking a definitive source code path through many iterations of the model attribute. Examples may also include a “smart expert system” aspect that enables the party (e.g., client, advisor, or firm) with the most accurate, up to date, or otherwise “best” data for any individual input to provide that data. The examples also enable firms to configure and evolve the platform to have more and more nuanced models based on their particular client bases or methodologies.

Examples may also include a “transparent single record” of the method, rationale and who provided the input through many iterations. These examples may also simultaneously provide for immediate feedback to the client, advisor, and/or advisor firm, and real time learning or real time provision of learning materials to clients, which is missing from some legacy systems. Legacy systems may take weeks or months to create, and may be created in an opaque manner where the client has limited input. Examples of this disclosure enable the advisor and client to co-create a financial model and financial plan in real time, with the inputs being transparent to both parties, and with the ability for the expert advisor to tweak various inputs and metrics based on real time learning about the client's interests and characteristics. A technical innovation of the present disclosure is the commingling of these combined functions into a single seamless platform that works in real time, rather than in a sequential, water fall approach.

With the above concepts in mind, examples may include a unique combination of intuitive data gathering, the ability to set and adjust advisor configurations and algorithms in real time, and to adapt the system with new inputs, better capturing the firms unique methodologies and learnings in real time. Examples include an expert learning system leveraging the expertise of multiple parties orchestrated in a way that allows for immediate delivery, learning and iteration in fast processing parallel manner where in the past industry solutions effected this serially and sequentially. Specifically, example systems and methods enable client data/metrics input, advisor data/metrics input, and firm data/metrics input, including the ability to configure assumptions to have multiple sets operating side by side. The systems and methods also enable client, advisor and firm collaboration with transparency and accountability in modeling initial results, exploring results, and refining, enabling the client, advisor, and firm to learn and revise together. The systems and methods create real time learning, with assumptions revealed in real time and transparently to all parties.

Any process descriptions or blocks in figures represented in the figures should be understood as representing modules, segments, or portions of code which include one or more executable instructions for implementing specific logical functions or steps in the process, and alternate implementations are included within the scope of the embodiments of the present invention in which functions may be executed out of order from that shown or discussed, including substantially concurrently or in reverse order, depending on the functionality involved, as would be understood by those having ordinary skill in the art.

1. A system for client-advisor collaboration comprising:
a server in communication with a client device, configured to receive one or more client metrics input via the client device;
a profiling engine in communication with the server and configured to:
receive the client metrics and the advisor metrics;
determine one or more implied client metrics based on the received client metrics; and
generate a plurality of client tags corresponding to a client based on (i) the one or more client metrics, (ii) the one or more implied client metrics, and (iii) one or more profiling rules; and
a learning engine configured to:
determine one or more knowledge entities based on the generated plurality of client tags; and
transmit the one or more knowledge entities to the client device.

2. The system of claim 1, wherein the one or more client metrics comprise at least one of a name, age, and income level.

3. The system of claim 1, wherein the profiling engine is further configured to determine the one or more implied client metrics by applying a fuzzy logic algorithm to the received one or more client metrics.

4. The system of claim 1, wherein each client tag comprises a qualifier and a value.

5. The system of claim 1, wherein the one or more knowledge entities comprise a set of discrete educational content items selected from a catalog of available educational content items.

6. The system of claim 5, wherein the learning engine is further configured to remove one or more educational content items from the catalog based on input from the client or the advisor.

7. The system of claim 1, wherein the learning engine is further configured to determine the one or more knowledge entities by applying a machine learning algorithm to the plurality of client tags.

8. The system of claim 7, wherein the machine learning algorithm is configured to include information corresponding to a plurality of previously determined knowledge entities and a corresponding plurality of previously determined client tags.

9. A system for client-advisor collaboration comprising:
a server in communication with a client device, configured to receive (i) one or more client metrics input via the client device and (ii) one or more advisor metrics;
a profiling engine in communication with the server and configured to:
receive the client metrics and the advisor metrics;
determine one or more implied client metrics based on the received client metrics; and
generate a plurality of client tags corresponding to a client based on (i) the one or more client metrics, (ii) the one or more implied client metrics, and (iii) one or more profiling rules; and
generate a plurality of advisor tags based on the one or more advisor metrics; and
a matching engine configured to determine a best matched advisor for the client based on one or more of (i) the one or more client metrics, (ii) the one or more implied client metrics, (iii) the plurality of client tags, (iv) the one or more advisor metrics, and (v) the plurality of advisor tags.

10. The system of claim 9, wherein the matching engine is further configured to determine the best matched advisor for the client by applying a machine learning algorithm to the plurality of client tags and the plurality of advisor tags.

11. The system of claim 10, wherein the machine learning algorithm is configured to include information corresponding to a plurality of previously determined client-advisor matches.

12. The system of claim 9, wherein the matching engine is further configured to:
determine one or more skill levels corresponding to a plurality of potential advisors in a plurality of skill areas;
update the skill levels based on feedback received from one or more clients; and
determine the best matched advisor based on the one or more skill levels.

13. The system of claim 9, wherein the matching engine is further configured to determine the best matched advisor based on (i) the one or more client metrics, (ii) the one or more implied client metrics, (iii) the plurality of client tags, (iv) the one or more advisor metrics, and (v) the plurality of advisor tags

14. A method for facilitating client-advisor collaboration comprising:
receiving, at a server in communication with a client device, (i) one or more client metrics, and (i) one or more advisor metrics;
determining, by a profiling engine in communication with the server, one or more implied client metrics based on the received client metrics;
generating a plurality of client tags corresponding to a client based on (i) the one or more client metrics, (ii) the one or more implied client metrics, and (iii) one or more profiling rules;
generating a plurality of advisor tags based on the one or more advisor metrics;
determining one or more knowledge entities based on the generated plurality of client tags;
transmitting the one or more knowledge entities to the client device; and
determining, by a matching engine, a best matched advisor for the client based on (i) the one or more client metrics, (ii) the one or more implied client metrics, (iii) the plurality of client tags, (iv) the one or more advisor metrics, and (v) the plurality of advisor tags.

15. The method of claim 14, further comprising determining the one or more implied client metrics by applying a fuzzy logic algorithm to the received one or more client metrics.

16. The method of claim 14, wherein each client tag comprises a qualifier and a value, and wherein each advisor tag comprises a qualifier and a value.

17. The method of claim 14, wherein the one or more knowledge entities comprise a set of discrete educational content items selected from a catalog of available educational content items, and wherein the method further comprises removing one or more educational content items from the catalog based on input from the client or the advisor.

18. The method of claim 14, further comprising determining the one or more knowledge entities by applying a machine learning algorithm to the plurality of client tags.

19. The method of claim 14, further comprising determining the best matched advisor for the client by applying a machine learning algorithm to the plurality of client tags and the plurality of advisor tags.

20. The method of claim 14, further comprising transmitting an indication of the best matched advisor to the client device.

21. A system for client-advisor collaboration comprising:
a server in communication with a client device, configured to receive one or more client metrics input via the client device;
a profiling engine in communication with the server and configured to:
receive the client metrics and the advisor metrics;
determine one or more implied client metrics based on the received client metrics;
generate a plurality of client tags corresponding to a client based on (i) the one or more client metrics, (ii) the one or more implied client metrics, and (iii) one or more profiling rules; and
a modeling engine configured to:
determine one or more client financial models based on the generated plurality of client tags; and
transmit the one or more client financial models to the client device.

22. The system of claim 21, wherein the modeling engine is further configured to determine the one or more financial models by applying a machine learning algorithm to the plurality of client tags.

23. The system of claim 22, wherein the machine learning algorithm is configured to include information corresponding to a plurality of previously determined financial models and a corresponding plurality of previously determined client tags.
